(19) United States
(12) Patent Application Publication
(10) Pub. No.: US 2019/0176945 A1
(43) Pub. Date: Jun. 13, 2019

(54) Acoustic Response Control System

(71) Applicant: Massachusetts Institute of Technology, Cambridge, MA (US)

(72) Inventor: Jules Ben Thomson, Ottawa (CA)

(73) Assignee: Her Majesty the Queen in Right of Canada, Ottawa (CA)

(21) Appl. No.: 16/212,021

(22) Filed: Dec. 6, 2018

Related U.S. Application Data
(60) Provisional application No. 62/595,779, filed on Dec. 7, 2017.

(51) Int. Cl. B63G 13/02; B63H 21/21; G05D 1/02; B63J 99/00

(52) U.S. Cl. CPC B63G 13/02; B63H 21/21; G05D 1/0206; B63J 2099/006; B63G 2013/022; B63H 2021/216; B63J 99/00

(57) ABSTRACT

A motion controller guides movement of a vessel in a manner that optimally balances performance and noise emitted by the vessel. During a training phase, for each of a plurality of states of a motion system, the controller measures 1) motion of the vessel concurrent with parameters of the motion system, and 2) acoustic response associated with the motion. A model representing the plurality of states is defined, where the model relates the parameters signals, vessel motion, and acoustic response associated with each of the plurality of states. During an operating phase, based on the model, the controller determines a subset of the plurality of states to satisfy a motion goal and an acoustic threshold. The controller then operates the motion system to maneuver the vessel according to the subset of the plurality of states.

### RELATED APPLICATION

This application claims the benefit of U.S. Provisional Application No. 62/595,779, filed on Dec. 7, 2017. The entire teachings of the above application are incorporated herein by reference.

### BACKGROUND

Typical marine vessels, such as surface ships, submarines, and unmanned marine vehicles, generate acoustic noise during operation. Much of this acoustic noise is generated by the propulsion and maneuvering systems of the vessel, as well as the flow of the vessel through the water. The acoustic noise can propagate far through the waters surrounding the vessel, potentially causing a number of adverse effects. For example, excessive acoustic noise can cause the vessel to be detected by hostile parties, or can interfere with local marine life. To avoid generating excessive acoustic noise, vessel pilots typically operate vessels at slower speeds when navigating waters where the acoustic noise is known to raise a concern.

### SUMMARY

Example embodiments include a method of operating a motion system of a vessel. During a training phase, for each of a plurality of states of the motion system, 1) motion of the vessel concurrent with parameters of the motion system may be measured, and 2) acoustic response associated with the motion may be measured. A model representing the plurality of states may then be defined, where the model relates the parameters signals, vessel motion, and acoustic response associated with each of the plurality of states. During an operating phase, based on the model, a subset of the plurality of states to satisfy a motion goal and a desired acoustic threshold can be determined. The motion system may then be operated to maneuver the vessel according to the subset of the plurality of states.

Determining the subset of the plurality of states may include 1) identifying a set of eligible states, the eligible states having an associated acoustic response below the acoustic threshold, and 2) determining a sequence of states selected from the eligible states, where the sequence of states satisfy the motion goal when performed by the motion system, and the subset includes the sequence of states. Operating the motion system may include controlling the motion system to perform the sequence of states to maneuver the vessel in accordance with the acoustic threshold. The sequence of states may enable the motion system to satisfy the motion goal in a minimal time period relative to alternative states.

The parameters may include at least one of a propeller shaft speed, a propeller pitch, a rudder angle, actuation of a control surfaces, a thruster direction, a thruster speed, a waterjet direction, a waterjet speed, and a dynamic ballast control value. The motion may include at least one of speed, turn rate, and acceleration of the vessel. The acoustic response may include at least one of frequency, amplitude, duration, and direction. The motion goal may indicates a required speed and direction of the vessel.

The motion goal may be determined based on a user-entered destination and time of arrival. Alternatively, the motion goal may also be determined based on a new user-entered desired course or speed. The acoustic threshold may be determined based on at least one user-entered value corresponding to at least one maximum amplitude and at least one frequency range. The maximum amplitude may represent a peak value or a time-averaged value. The acoustic threshold may indicate a frequency range and a respective amplitude. The acoustic threshold may be “persistent” in that it can remain at fixed value until changed by the user, or it may be “dynamic,” wherein the value changes relative to another changing variable such as the ambient noise level. The plurality of states may be distinct from one another via at least one of the respective parameters and the motion. The acoustic response may be based on input measurements of at least one acoustic sensor and/or accelerometer at the vessel. The motion goal may indicate a user-entered speed and a user-entered direction, and wherein the subset of the plurality of states indicate a speed and a direction that may be distinct from the user-entered speed and the user-entered direction.

A motion command may be modified to correspond to the parameters of at least one of the subset of states. During the operating phase, the model may be updated based on a measured acoustic response. The model may include a map of the parameters, motion, and acoustic response associated with each of the plurality of states. The parameters of the motion system include at least one of commands directed to the motion system and a feedback signal output by the motion system. A navigation plan may be received from an electronic charts system (ECS), where the navigation plan defines a plurality of movements to be executed by the vessel. The navigation plan may be modified, based on the model, to determine a modified plurality of movements that, when executed by the vessel, satisfy the acoustic threshold.

Further embodiments may include a method of training a vessel maneuvering and propulsion system. Acoustic energy output to water at a vessel as a function of operating states and motion of the vessel to produce a cause-effect acoustic model may be observed. The vessel maneuvering and propulsion system may then be trained for at least a subset of maneuvering and propulsion states based on the cause-effect acoustic model.

Further embodiments include a method of operating a motion system of a vessel. A motion goal and an acoustic threshold may be applied to a model representing a plurality of states of the motion system, where the model relates parameters directed to the motion system, motion of the vessel, and acoustic response associated with each of the plurality of states. Based on the model, a subset of the plurality of states to satisfy the motion goal and acoustic threshold may be determined. The motion system may then be operated to maneuver the vessel according to the subset of the plurality of states.

Further embodiments may include a system for operating a vessel. At least one acoustic sensor may be configured to measure an acoustic response of the vessel. A controller may be configured to interface with a motion system of the vessel. The controller may be further configured to engage in a training phase and an operating phase. During the training phase, the controller may, for each of a plurality of states of the motion system, 1) measure motion of the vessel concurrent with parameters of the motion system, and 2) measure acoustic response associated with the motion. The controller may further define a model representing the plurality of states, the model relating the parameters, motion, and acoustic response associated with each of the plurality of states. During the operating phase, the controller may determine, based on the model, a subset of the plurality of states to satisfy a motion goal and an acoustic threshold, and may then operate the motion system to maneuver the vessel according to the subset of the plurality of states.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a block diagram of a vessel in which example embodiments may be implemented.

FIG. 2 is a block diagram of a discretized state in an example embodiment.

FIG. 3 is a block diagram illustrating a calibration stage in one embodiment.

FIG. 4 is a block diagram of an acoustic response model in one embodiment.

FIG. 5 is a block diagram illustrating an operate stage in one embodiment.

FIG. 6 is a flow diagram of a process of determining a successive state in one embodiment.

FIG. 7 is a flow diagram of a process of determining a successive state in a further embodiment.

FIG. 8 is a block diagram of a vessel control system in a further embodiment.

### DETAILED DESCRIPTION

A description of example embodiments follows.

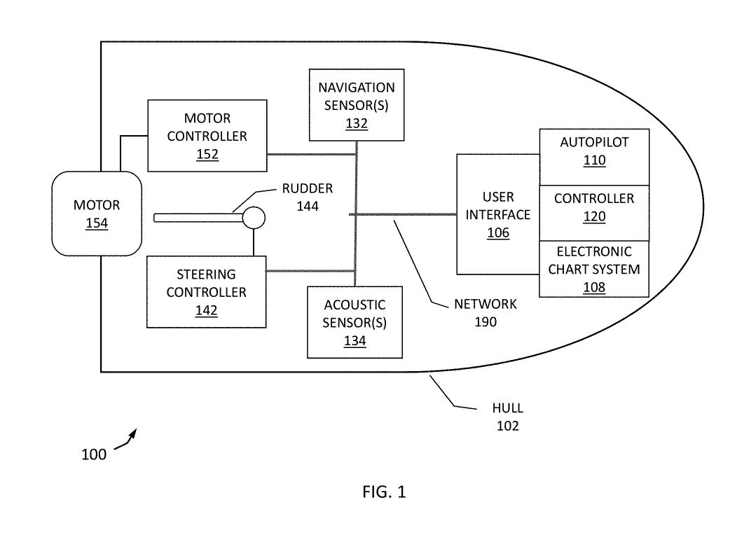

FIG. 1 illustrates a vessel 100 in which example embodiments may be implemented. Although the vessel 100 is a surface ship piloted by a human operator, example embodiments may also be implemented in other vehicles, such as submarines and unmanned marine vehicles. The vessel 100 is shown in a simplified, top-down view, with attention to the motion and control systems responsible for movement of the vessel 100.

In order to operate the vessel 100, a pilot (not shown) may interact with a user interface 106 to monitor the status of the vessel 100 and issue commands corresponding to a motion goal. For example, the pilot may enter one or more motion goals directly into the user interface 106 to the autopilot in which to change direction or speed. Alternatively, the pilot may plot a series of direction and/or speed changes into an Electronic Charting System (ECS) 108 to be carried out in succession to complete one or more of a desired destination, and a desired time of arrival. An autopilot system 110 receives the user-entered commands and translates the motion goal into specific propulsion and maneuver commands (or a sequence of commands) to operate the motion system of the vessel 100. A controller 120 may optionally modify those commands as described in further detail below.

A motor controller 152 and a steering controller 142 may be communicatively coupled to the autopilot 110 and controller 120 via a network (e.g., a wired or wireless communications network). The motor controller 152 may receive the propulsion commands from the autopilot 110 and drive a motor 154 accordingly. The motor 154 may implement a propeller assembly or other propulsion system for propelling the vessel. Likewise, the steering controller 142 may receive the maneuver commands from the autopilot 120 and control a rudder 144 accordingly. Together, the motor 154 and rudder operate to drive and steer the vessel 100 through the movements directed by the autopilot 110 to satisfy the motion goals set by the pilot.

A state of the vessel 100 at a given point in time may be referred to as the “ship-propulsion state.” The ship-propulsion state is the set of input information that is needed to fully define what the vessel, maneuvering control system, and propulsion system are doing at the given point in time. The ship-propulsion state may vary in complexity based on the application. A simplified ship-propulsion state can be comprised of a single variable that simply defines the amount of power being used for propulsion under steady speed conditions without maneuvering. A more complex ship-propulsion state may contain at least three variables: the ships speed, the power being exerted by the propulsion system, and the new desired ship speed. Depending on the application, there may be flexibility in terms of which variables are used. For example, it may be advantageous to use shaft speed (rpm) instead of propulsion power, or to use new desired power instead of new desired ship speed. An advanced system may have a ship-propulsion state that includes even more variables, such as the status of the maneuvering control system, the motion of the ship (in terms of yaw pitch and roll), the pitch angle of a controllable pitch propeller (CPP), and the associated rates of change for each of these variables. The complete list of parameters that make up the ship-propulsion state can be further subdivided into input parameters and output parameters.

In order to determine the ship-propulsion state, the vessel 100 can further include navigation sensors 132, which can include range of equipment that assists in navigating the vessel and avoiding collision. Examples of navigation sensors 132 include a GPS (providing position, heading, and ground speed), a Doppler speed log (providing speed through the water), and a gyrocompass (providing heading). Medium-sized and larger vessels may also have radar and an echo sounder (to measure water depth). Larger commercial vessels and military vessels may be equipped with an electronic charts system, which automatically takes data from other navigation sensors and incorporates the data with digital charts (e.g., maps) to help the crew to navigate. In addition, military vessels may have an inertial navigation system (INS) that provides heading, pitch, roll, ground speed, acceleration/deceleration, and positional information.

During operation, the vessel 100 generates an acoustic response, which refers to near-field and far-field acoustic noise that is generated outwardly from the vessel 100, as well as vibrations that are transmitted internally into the ship structure or within the equipment itself, depending on the application. The acoustic response can be a single variable, such as only broadband noise amplitude or power, or it can also contain multiple single variables such as recording both Root Mean Square (RMS) amplitude and peak amplitude. Alternatively, the acoustic response can be multi-variable, where, for example, the amplitude is measured separately, and sub-dived into several different frequency bands. The latter could be useful in applications where only specific frequencies are paramount for optimization. Calculated acoustic response variables can be found by combining other variables, or by integrating or differentiating the variables with respect to time. For example, noise duration can be measured by counting the number of successive acoustic response samples with matching frequency amplitude profiles. Likewise, the rate at which noise levels are increasing or decreasing can be found by differentiating amplitude with respect to time.

To determine the acoustic response of the vessel 100, the vessel 100 can include acoustic sensors 134. The acoustic sensors 134 can include a range of sensors that are used to measure the acoustic response. In the case of internal ship vibrations, accelerometers may be used. For near- and far-field acoustic noise, pressure transducers/hydrophones or accelerometers may be used. The acoustic sensors 134 can be either fitted to the vessel 100 such as with hull-mounted hydrophones, or towed by the vessel as with a towed array. However, acoustic response can also be measured using sensors that are geographically fixed in the water, using deployable buoy sensors, or fitted or towed by another vessel.

The acoustic noise generated by the vessel 100 can present a number of challenges. Merchant ships, for example, can emit acoustic noise that interferes with local or even distant marine life. Unmanned vehicles that use acoustic sensors can generate noise that interferes with their own sensors, reducing their ability to navigate and search. For military applications where stealth is required, excessive noise can be detected by hostile acoustic sensors, allowing the vessel to be detected.

Example embodiments provide for operating a vessel in a manner that optimizes a balance between the vessel's ability to maneuver and the acoustic noise radiated by the vessel. Such optimization enables a vessel to maneuver at the highest speed that also complies with a desired acoustic performance. Through the discretization of both the vessel's motion and all possible configurations for the vessel's propulsion and control systems, a finite number of unique states can be created. Example embodiments may learn the cause-and-effect relationship between the finite states of the ship and the resulting acoustic noise and vibrations which are generated. Once this relationship is determined, it can be implemented to predict the amount of acoustic noise that would be generated by a proposed propulsion change or maneuver. In this context, any maneuver or speed change can be considered a state change. Accordingly, an optimal new end state can be determined, along with intermediate states that provides the greatest speed, acceleration, and ability to maneuver without exceeding user-defined acoustic thresholds unnecessarily.

Example embodiments can confer several advantages to a vessel:

Sensor Optimization:

Applicable to submarines, surface combatant ships, research vessels, survey vessels, and unmanned vehicles (UVs). In general, own-ship noise (OSN) is reduced at lower speeds; however, higher speeds are desired in which to maximize the search coverage. An example embodiment, having a response threshold set for the frequency and the anticipated returned signal strength for the item being searched for, can then control the host vessel at an optimized speed, thereby giving the best coverage while maintaining the maximum likelihood of sensors detecting the item. Examples applications include a warship searching for a submarine, or a group of unmanned surface vehicles (USVs) searching for the black-box transmissions from an aircraft lost at sea. In order to avoid certain combinations of amplitude and frequency, this does not necessarily require the host vessel to reduce speed, as an increase in speed may also provide a frequency shift in OSN, achieving the desired effect.

Signature Reduction (Stealth):

Applicable to submarines, surface combatant ships, and military UVs. To maintain a tactical advantage, ship operators and designers want to minimize the likelihood of being detected by hostile vessels, while at the same time not overly restricting their own ability to maneuver (speed, acceleration, and depth/course changes). An example embodiment, calibrated with a threshold that matches the anticipated hostile sensor capabilities, can give the host platform the maximum ability to maneuver while minimizing the likelihood of being detected by hostile platforms. Optimization can be achieved by controlling the propulsion and maneuvering control systems, as well as avoiding certain conditions where excessive noise/vibration is generated, such as with propeller cavitation or hull resonances. A military-specific application is with the use of acoustic (noise-making) countermeasures that act as decoys against hostile torpedoes. The platform employing the countermeasure will want to distance itself from the decoy as quickly as possible, while at the same time, it does not want to generate more noise than the countermeasure. This is where optimizing the ability for the ship to maneuver away from the countermeasure while staying below the response threshold of the countermeasure could provide a significant tactical advantage. Stealth optimization can make use of a “dynamic” value for the acoustic threshold. For example, the system could perform optimal maneuvers, based on an acoustic threshold, where the acoustic threshold itself would be relative to the real-time measured ambient noise levels. Practically speaking, this means the system can automatically adjust to maneuver the host vessel more aggressively when there are third-party noise sources present that further mask the host vessels acoustic signature.

Environmental Considerations:

Applicable to merchant vessels, drilling platforms, pleasure craft/cruise ships, and government-owned vessels that operate in or near environmentally sensitive waters. Noise generated by marine traffic, especially at certain frequencies, has negative effects on certain marine life. It is possible that in the near future, governments will impose prescriptive restrictions that will limit which types of vessels are permitted in these protected waters, and/or impose speed limitations. As the acoustic noise produced by vessels varies greatly, even within the same class of ship, these prescriptive restrictions may not provide adequate protection to marine life in some cases, and may be unnecessarily prohibitive in other cases, forcing adequately quiet ships to unnecessarily circumnavigate the protected areas. Given specific frequency and amplitude thresholds for an environmentally protected area, an example embodiment can determine if a vessel is able to operate within the required noise thresholds, and if so, allows the vessel to operate as efficiently as possible within these restrictions. Data logged by a control system of the vessel can be used as evidence of environmental compliance. For example, the controller 120 may store both acoustic information, such as audio, as well as log files. One embodiment may use the audio for later analysis or to be used for an active noise cancellation (ANC) system. Log files of actual noise levels may be used with navigational information to prove compliance with local regulations or noise-related incentives.

Crew and Passenger Comfort:

Applicable to all civilian platforms, particularly passenger ships and pleasure craft. In addition to externally radiated noise, vibration and noise from the propulsion system is also transmitted inwards through the ship structure, where it affects crew-occupied spaces. Health and safety regulations limit crew exposure to noise and vibrations. An example embodiment may allow operators to optimize the balance between passenger comfort and platform performance.

Referring again to FIG. 1, the controller 120 may be configured to communicate with one or both of the user interface 106 and autopilot 110 to interpret a desired motion goal in the context of the potential acoustic response generated by the vessel 100. Based on this interpretation, the controller 120 may issue corresponding propulsion and maneuver commands to the motion system (e.g., the steering controller 142 and motor controller 152) that it determines to satisfy the motion goal while also maintaining the vessel 100 below a given acoustic threshold. The controller 120 may determine those propulsion and maneuver commands as those that are optimal to satisfy the motion goal (e.g., enable the vessel 100 to reach the desired destination in the shortest time), while also complying with the acoustic threshold. Alternatively, the controller 120 may receive initial propulsion and maneuver commands from the autopilot 110, and modify those commands to achieve the same goals.

To determine the aforementioned propulsion and maneuver commands, the controller 120 may first determine a relation between the aforementioned ship-propulsion state (including propulsion and maneuver commands and other information as described above) and the aforementioned acoustic response that corresponds to the ship-propulsion state. During a configuration or “training” phase, the controller 120 may make this determination for a range of ship-propulsion states by observing operation of the vessel, along with corresponding acoustic response, over a period of time. The controller 120 may then discretize the observed operation into a number of states, where each state includes a given ship-propulsion state and a corresponding acoustic response. Then, during future operations, the controller 120 may reference the discretized states to determine propulsion and maneuver commands that achieve an optimal balance between satisfying the desired motion goals and maintaining the vessel 100 below a desired acoustic threshold or to exceed the acoustic threshold as little as possible. The acoustic threshold may include one or more static values (e.g., decibel level and corresponding frequency range) that are set by a user. Alternatively or in addition, the acoustic threshold may include a relative threshold that is determined based on a measured acoustic response of the environment in which the vessel is located (e.g., the ambient noise). For example, an acoustic threshold may be set to a percentage of a measured ambient noise at a given frequency. Such a setting may be useful in environments where existing noise pollution renders sound control measured unnecessary.

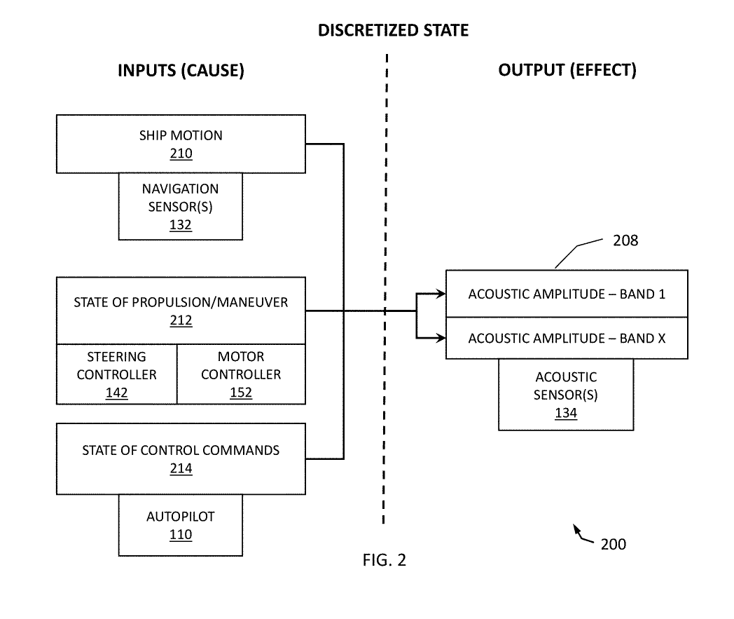

FIG. 2 illustrates a discretized state 200 in an example embodiment. The state 200 may be divided into inputs that represent an aforementioned ship-propulsion state as the causes of an acoustic response, and outputs that represent the acoustic response itself (the effect). Referring to FIG. 1, the controller 120 may communicate with several components of the control and motion systems to observe and record values corresponding to the inputs and outputs. In particular, the controller 120 may observe the ship-propulsion state based on ship motion 210 provided by the navigation sensors 132, the state of the propulsion and maneuver systems 212 provided by the steering controller 142 and motor controller 152, and/or the state of control commands 214 provided by the autopilot 110. Alternatively, or in addition, the controller 120 may receive other information on the ship-propulsion state from other components of the vessel 100. For example, the steering controller 142 and motor controller 152 may also provide information regarding the motion of the vessel 100.

To observe the acoustic response, the controller may receive one or more acoustic amplitudes 208 from the acoustic sensors 134. Each of the acoustic amplitudes 208 may be specific to a given frequency band, where the bands can be configured based on acoustic frequencies of interest. For example, one of the acoustic amplitudes may have a frequency band known to interfere with certain marine life. For the given discretized state 200, each of the inputs 210, 212, 214 and outputs 208 may be observed concurrently, which may include a limited timeframe allowing for latencies in measurement or reporting, or to allow for the acoustic effect of a commanded action to be observed.

As an alternative approach for predicting acoustic response of the vessel, analytical or numerical simulation methods may be used to model and predict the acoustic responses of a marine propulsion system. However, such approaches may have limitations. For example, there are multiple sources of noise caused by numerous interactions between propulsion, hull, and control surfaces paired with dynamic water conditions that make even steady-state predictions cumbersome. Unsteady and non-uniform flow conditions are even more difficult to model and predict. Analytical and numerical simulations are usually built to model one specific class of marine vessel, and cannot be easily adapted to other platforms without new simulations or experiments. Additionally, numerical simulations and software-modeled predictions can be computationally demanding, and the results may not be available quickly enough to be used in pseudo real-time systems.

Example embodiments, in contrast, can implement an adaptive process to learn the cause-and-effect relationship between the propulsion and maneuvering systems, together with the ship's motion (ship-propulsion state), and the resultant acoustic responses generated. Such embodiments can, in effect, bypass the need for modeling and a full understanding of all the aforementioned interactions by mapping the cause-and-effect relationships directly. Because the process includes learning the propulsion and control parameters of the host platform (e.g., the autopilot and other controllers), it can be applied to various platforms with minimal variation in the hardware/software configuration. Thus, by using a process that uses a vessel's actual movements and real-world measured response to directly develop an approximate relationship between them, a vessel-specific response prediction tool can be developed without the need for laboratory modeling or simulation. Additionally, with the use of general experienced-based algorithms, the same hardware and software can be used for different marine vessels, without the need to significantly vary its configuration. Further, example embodiments may use the learned cause-and-effect relationship to control the host platform with optimal maneuverability so that the user-defined acoustic response thresholds are not exceeded where possible.

One particularly difficult condition to predict and model is the propeller noise that occurs when the ship is transitioning between speeds. During aggressive maneuvers and quick speed changes there will be significant forced propeller slip, which refers to when the propeller is slipping more than the steady-state propeller slip because of a mismatch between the speed of advance and rotational speed (angular velocity) of the propeller. Many ships are able to change the speed and direction of the propulsion system much more quickly than then the actual speed or direction of the entire vessel. This is not only because the propulsion system must change speeds first in which to develop the new thrust in order to change the speed of the ship, but also because of the relative mass differences between the moving parts of the propulsion system and the ship itself. For example, a large merchant ship with a fixed-pitch propeller that is traveling forward at speed may require using a reverse-thrust to slow or stop. Reversing the direction of rotation of the shaft using the engines can be done relatively quickly, and the shaft will achieve a steady rotational speed in the reverse direction long before the ship slows to a halt due to momentum. A ship moving forward with the shaft turning in reverse will produce a very different flow across the propeller and hull than a ship moving in reverse with the shaft also turning in reverse. For this reason, the state of the propulsion and control systems, as well as the movement of the entire ship all should be considered and included together in which to create the various ship-propulsion states.

Many propellers are optimized for a steady flow, as ships often spend far more time at a given speed rather than frequently changing speeds. The different flow and interactions among the components of the motion system may inevitably produce different acoustic responses. Each acoustic response may also be unique to each combination of hull and propulsion system. With so many different marine vessels, it is advantageous to use a singular, common process that can adapt to each marine vessel.

As described above, example embodiments can undergo a calibration stage to observe and record the discretized states, such as the state 200, over a period of time in which the vessel operates. Following this calibration stage, the example embodiment may transition to an operational stage, where the recorded discretized states are referenced to determine optimal movement of the vessel under given acoustic thresholds. Example calibration and operational stages are described in further detail below.

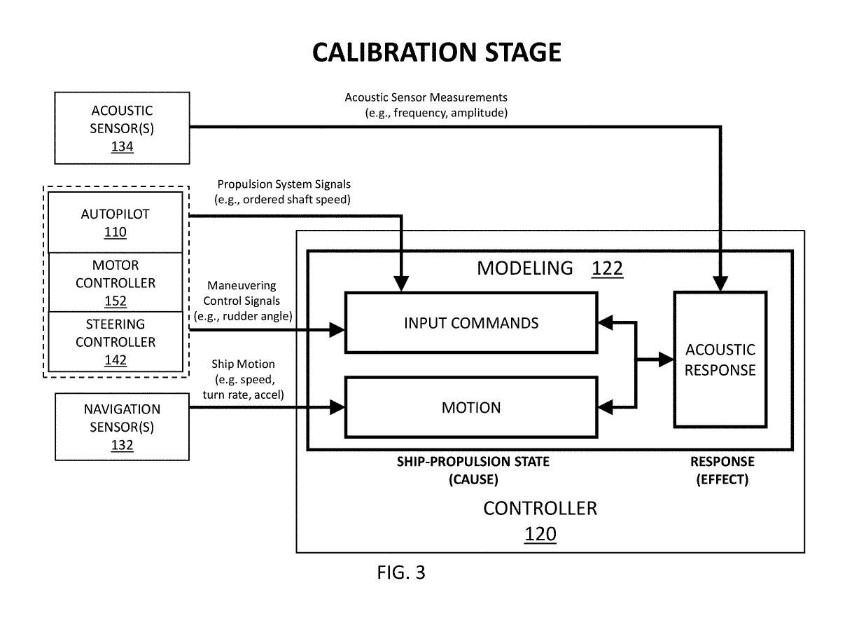

FIG. 3 illustrates the controller 120 engaging in a calibration stage in one embodiment. With reference to FIG. 1, during this stage, the controller 120 may engage a modeling process 122 (FIG. 3) to define an acoustic response model for the vessel 100. The modeling process 122 operates to determine a number of discretized states (e.g., the state 200 of FIG. 2) as the vessel 100 operates through a range of movements. For each state to be discretized, the process 122 may receive information representing a number of parameters of the motion system and the acoustic response, such as 1) propulsion system signals (e.g., ordered shaft speed) and maneuvering control signals (e.g., rudder angle) from one or more of the autopilot 110, motor controller 152, and steering controller 142; 2) ship motion (e.g., speed, turn rate, acceleration) from the navigation sensors 132, and 3) acoustic sensor measurements (e.g., frequency, amplitude) from the acoustic sensors. The modeling process 122 may then relate those parameters to define a corresponding discretized state, such as the discretized state 200 of FIG. 2. This action may also be referred to as data mapping, where the various data representing the state of the vessel and the acoustic response are mapped to one another. The modeling process 122 may continue as the vessel 100 enters subsequent states (e.g., changing speed, turning, or other parameters), and may also record those discretized states to develop an accurate model of the vessel 100 and its acoustic response through a range of different operations.

The calibration stage therefore enables example embodiments to build the cause-effect relationship between how the vessel is moving and the amount of acoustic noise generated. Information representing how the ship is moving can be captured as a discrete state as described above with reference to FIG. 2. Depending on how many different ship movements being optimized, it will also determine how complex the system may be required to be. In cases such as merchant ships, where speed and course changes are infrequent, and the consequences of exceeding response thresholds during these occasions are minor, the calibration of the controller 120 may be more straightforward. For the application of a warship taking evasive maneuvers for example, speed and maneuvering interactions may be more important, and the consequence of exceeding response thresholds, even for short periods of time, may be severe. Therefore, for the latter application, a more complex calibration, involving a more detailed model, may be required. The complexity of the system can determine how many variables need to be captured in the ship-propulsion state.

For every variable that is to be included in the ship-propulsion state, example embodiments provide a way to measure or calculate the values of these variables. The values for measured variables originate from both input parameters that are directly controlled, such as rudder angle and throttle speed, and also from input parameters that are directly controlled, such as the vessel's axial speed. The values for parameter inputs may originate from sensors, or can be taken from command signals or from the sensors already built into the equipment. Calculated variables can be found by combining other variables, or by integrating/differentiating the variables with respect to time. An example of calculated values includes deriving acceleration from speed, or vice versa. Another example includes measuring the turning rate of the ship based on how the heading changes with respect to time.

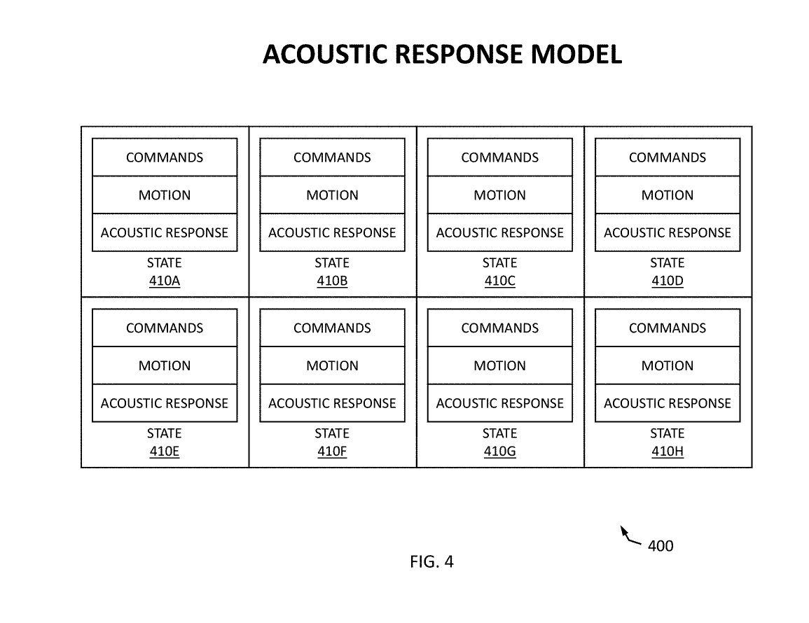

FIG. 4 illustrates an acoustic response model 400 that may be generated during a calibration stage in one embodiment. With reference to FIG. 3, the model 400 comprises several discretized states 410A-H that are recorded by the controller 120 operating the modeling process 122 as described above. Each of the states 410A-H may also include some or all of the observed data for the respective state as described above, such as the issued commands, measured movement of the vessel 100, and the acoustic response. The model 400 can be structured in a number of different ways. For example, the model 400 may incorporate the data of the discretized states 410A-H into a data array structure or a data vector equivalent, or into a relational database or data map that associates related values and/or categories.

An example implementation of the vessel 100 as a merchant ship illustrates how information may be processed during a calibration stage as shown in FIGS. 3 and 4. In this example, the owners of the ship wish for the vessel to be able to operate in environmentally protected waters. To do so, they intend to reduce low-frequency noise being generated by the vessel 100 at sustained speeds, which interferes with marine mammals' ability to communicate. In this case, with speed changes occurring infrequently, the short bursts of noise and vibration during these transitions are deemed to be acceptable. The vessel 100 may, however, need to make regular rudder movements in which to correct for sea currents and wind. Accordingly, the controller 120 may be configured to have three variables for this case in which to define the applicable ship-propulsion state: 1) engine throttle as percentage of full power P, 2) rudder angle δ, and 3) rudder angle rate. The rudder angle rate can be calculated as the first derivative of the rudder angle with respect to time. Therefore, the ship-propulsion state (SPS), which is the “cause” in the data map, is a function of these three variables as shown in Equation (1):

$$Cause = SPS = f ( P , δ , \frac{d}{dt} δ ) \qquad ( 1 )$$

Further, an equivalent expression can express the acoustic response. Because the ship owners have concerns about both amplitude and frequency, the acoustic response (AR), which is the “effect,” can be defined as a function of root-mean-square amplitude (A_{RMS}) and frequency (freq) as per Equation (2):

Effect=AR=f(A_{RMS},f_{req}) (2)

Before the data mapping begins, both the cause and effect variables may be discretized into a finite number of elements. The number of elements can depend on the level of precision required and the amount of processing power and memory available. For example, the rudder angle can be discretized into 3-degree divisions, 1-degree divisions, or into divisions that are only a fraction of a degree. Depending on the algorithms used, the divisions do not need to be of equal sizes, but combined, all divisions may span the full range of motion. This approach will allow for interpolation. In this example, there would likely need to be at least three divisions for frequency: one division is needed for the frequency band where marine mammals communicate, which is a known entity, and the other two elements would be the frequency bands above and below, in order to span the full range of relevant frequencies.

During the calibration stage, a model of the vessel 100 including several discretized states can be created as the ship adopts the various ship-propulsion states. Depending on the method and level of sophistication of the experience-based machine learning algorithms used, the controller 120 can determine how many of the possible permutations of the ship-propulsion states need to be explicitly adopted and measured. The controller 120 can also determine for how long data needs to be gathered at each ship-propulsion state in order to provide adequate levels of confidence and error rejection. The calibration can occur over long periods of time, being measured as the ship is operated normally, or dedicated calibration maneuvers can be conducted in which to specifically feed the controller 120 with the required range of ship-propulsion states. Either way, the controller 120 can create a model that matches the permutation of the ship-propulsion states to the measured acoustic response. The controller 120 might be able to operate (with reduced confidence) with incomplete data.

Using machine learning techniques, the controller 120 can create a simplified model using a “brute force” technique to populate a data array structure or the data vector equivalent. An array is simply an ordered list of elements. To create multidimensional arrays, additional arrays are simply stored as elements within a parent array. For example, storing one-dimensional columns of data as elements into another array forms a two-dimensional array, which is effectively a table of rows and columns. In the example described above, a three-dimensional array is sufficient to encompass all of the permutations of the three-variable ship-propulsion state. A one-dimensional array is needed to span all permutations of the acoustic response. When the model is created, for every element of the three-dimensional “cause” array, a one-dimensional “effect” array will be assigned. In this example there are three frequency bands: (Band1, Band2, Band3), and therefore, each effect array would contain these three elements. If we use the imperative assignment “:=” to represent “is assigned the value of”, a data map assignment could look like:

$$Cause [ P , δ , \frac{d}{dt} δ ] \text{:=} [ {A}_{RMS , Band 1} , {A}_{RMS , Band 2} , {A}_{RMS , Band 3} , ] \qquad ( 3 )$$

To continue the above example, from the acoustic sensors 134, hypothetical data can be introduced. When the vessel has a steady rudder at 0-degrees, and 50% throttle, the RMS amplitude values for each of the three bands were measured to be 0.123, 0.456, and 0.789 respectively. For the purpose of this example, the throttle array (as % power) contains 201 elements spanning from −100% to 100% in 1% increments, and the rudder has 91 elements spanning from −45° and 45° in 1° increments. The minimum and maximum rudder rates are −5 and 5°/s respectively, and are spread over 11 divisions. Assuming the data structure uses the convention that the first element of an array is the zeroth element, then a throttle of 50% would be the 150th element of the throttle array. 0° of rudder angle would be the 45th element of the rudder array and 0°/s would be the 5th element of the rudder rate array. Inserting these numerical values into Equation (3) gives Equation (4):

Cause[150][45][5]:=[0.123,0.345,0.567] (4)

Further, internal vibrations can be managed concurrently in the above example. For example, an accelerometer may be included in the navigation sensors 132, and the controller 120 may add another dimension to the “effect” array. Instead of having a single, one-dimensional array containing acoustic sensor data, it would now have a second one-dimensional array with the latter containing the measured values of the accelerometer. The “effect” array would then be essentially an array of arrays, making it a two-dimensional array. As with the acoustic response, the vibration response may be divided up into several separate frequency bands with individually set limits, as people experience different levels of discomfort at different frequencies. The number of frequency divisions again corresponds to the number of elements in this new one-dimensional array. In this example, the vibration response array and the acoustic response array do not need to have the same number of frequency divisions.

Once a calibration stage is complete and a corresponding acoustic response model is generated, an example embodiment may then enter an operate stage to optimize movement of a vessel. An example operate stage is described in further detail below.

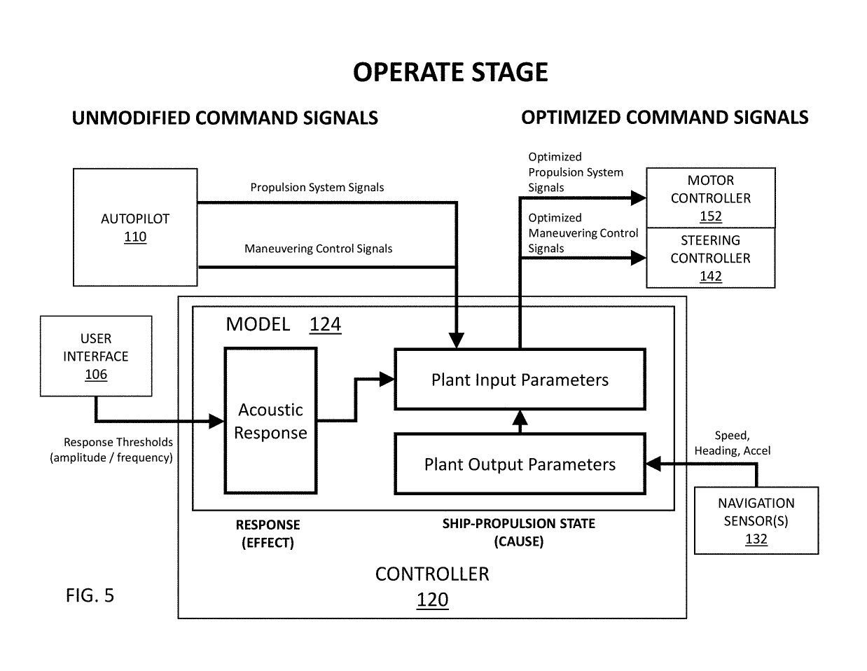

FIG. 5 illustrates the controller 120 engaging in an operate stage in one embodiment. The controller 120 may implement an acoustic response model 124, which may be comparable to the model 400 described above with reference to FIGS. 3 and 4. Here, the model 124 may serve as a reference to determine optimal command signals to the motion system of the vessel 100. To determine the optimal command signals, the controller 120 may receive one or more acoustic response thresholds via the user interface 106. The acoustic response thresholds may be entered by a pilot or other user at the user interface 106, and may specify a maximum amplitude for one or more frequency bands, indicating the specific acoustic parameters that are desired not to be exceeded during operation of the vessel 100. The controller 120 may also receive data on the vessel's speed, heading and acceleration from the navigation sensors 132, as well as propulsion system signals and maneuvering control signals (“unmodified command signals”) from the autopilot 110, which correspond to the initial commands issued for a given movement. Rather than forwarding those command signals directly to the motion system, the controller 120 may instead pass them, along with the acoustic response threshold, to the model 124. For example, the controller may compare the acoustic response threshold and command signals to corresponding values of one or more discretized states of the model 124.

Based on this comparison, the controller 120 can predict whether the unmodified command signals will cause the vessel 100 to exceed the acoustic response thresholds. If so, then the controller 120 may then determine optimized command signals that enable the commanded maneuver at maximum performance while also complying with the acoustic response thresholds. The controller 120 may then output these optimized propulsion system signals and maneuvering control signals to the motor controller 152 and steering controller 142, respectively.

During the operate stage, the controller 120 may make use of the cause-effect relationship between how the vessel 100 is moving and the amount of acoustic noise generated in which to optimize the command signals to the propulsions and maneuvering systems without exceeding the defined response thresholds. Within the operate stage, there can be several sub-stages, and a range of different processes can be implemented. In one example, the following sub-stages may be used each time the vessel's crew request a new desired speed or new heading:
a) Determine the current ship-propulsion-state.
b) Convert the new desired speed/heading into a desired steady ship-propulsion state.
c) Use the data map to determine which ship-propulsion state best matches the desired state and also has an assigned acoustic response that is less than the response threshold.
d) Determine the intermediate ship-propulsion-states required to get from the current to the desired ship-propulsion state without also exceeding response thresholds.
e) Incrementally command the maneuvering and propulsions systems with modified command signals corresponding to the next incremental state. This sub-stage may be repeated for each incremental state until the desired ship-propulsion-state is achieved.

Sub-stage (b) refers to “steady ship-propulsion state.” Many marine vessels, when transiting, try to operate at a constant speed and heading for each leg of their journey. With the exception of specialty vessels, such as those with dynamic positioning systems, many ships are more fuel efficient and will spend a far greater amount of time at a constant speed and heading then they do altering their heading or changing their speed. Thus, in this context, a “steady” ship-propulsion state means a constant heading and speed. “Steady” in this context does not preclude feedback control to make regular error corrections, such as small rudder angles and small rudder movements to correct for external disturbances. It may be intentional to capture the additional noise generated by these small movements during the calibration stage, as they will also be required here in the operate stage. A data-mapping process in some embodiments can measure environmental conditions, such as sea state, and can include the measurements in the ship propulsion state. Doing so would allow the controller 120 to effectively adjust to different sea states.

The “best match,” as described in the sub-stage (c), does not necessarily mean that if the desired state requested by the operator has an assigned acoustic response that exceeds the response thresholds, that a slower or more conservative ship-propulsion-state will be selected by the controller 120. Often, more aggressive speeds tend to increase the broadband noise response. However, when considering frequency bands with individually-set thresholds, adopting a more aggressive speed may be preferential. For example, the example merchant ship described above with reference to FIG. 3 set a goal to avoid frequencies used by marine mammals. In this context, a lot of noise at a higher frequency is more desirable than moderate noise levels at the frequencies to be avoided. In this case, having the ship drive at a slightly faster speed may provide enough of a frequency shift to satisfy the response thresholds. For a given application, the controller 120 may allow for the operator to set how far above or below the desired speed they are willing to accept. Accordingly, the controller 120 may undergo a process to select the “best match within the available range” and notify the operator when they are exceeding the response threshold, and by how much.

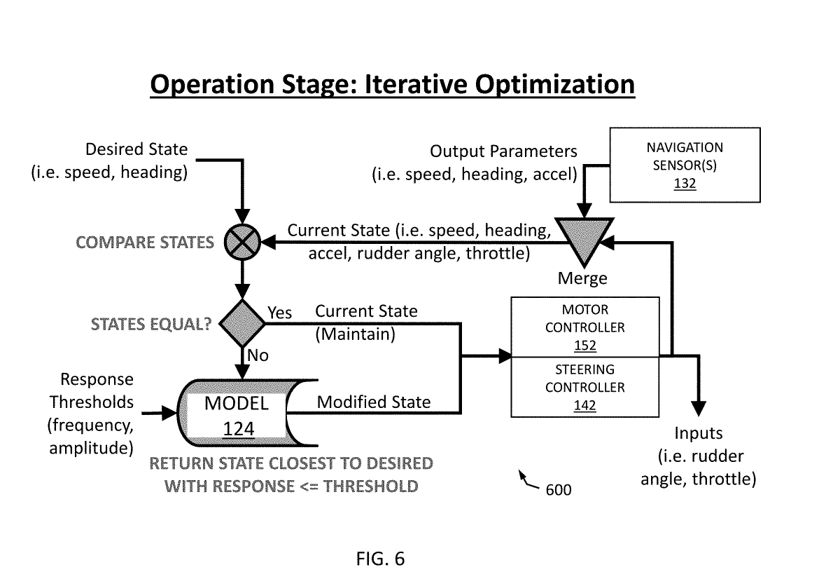

FIG. 6 is a flow diagram illustrating an example process 600 that may be implemented by the controller 120 for determining successive states of the motion system. As shown, the controller 120 may compare a desired state (e.g., speed and heading commands) to the current state of the vessel motion system (e.g., speed, heading, acceleration, rudder angle, throttle) obtained from the navigation sensors 132, motor controller 152 and steering controller 142. If the states are equal, the controller may maintain the current state. If the states are not equal, then the controller may apply the desired state, along with the acoustic response thresholds, to the model 124 to determine a modified (optimal) state as described above with reference to FIG. 5. The controller 120 may then issue commands corresponding to the optimal state to the motor controller 152 and steering controller 142.

During the operate stage, the controller 120 may be further configured to select the best intermediate states while transitioning from the current steady ship-propulsion state to the desired ship-propulsion state. However, even when both the current and desired ship-propulsion states are within the response thresholds, the states between them may not be. A simplified process by the controller 120 may simply choose the next best intermediate state, even if that precludes better options in the future. In doing so, the controller 120 may temporarily adopt a state that exceeds the response thresholds, or choose not to reach the desired state at all. A more complex process may map out the entire path to the new desired steady ship-propulsion state, and may also consider the time spent to complete the transitions. For example, if both speed and heading changes were requested at the same time, there would be multiple decisions for the best path. To find the best overall path, it may be advantageous to change both throttle and rudder angle concurrently at some points along the path, while it may be better to change them independently for other points. For example, it may faster and quieter to 1) speed up without applying rudder up to a speed where turning rate is optimal, 2) stay at that speed to complete the turn, and then 3) resume speeding up after the turn is complete. Thus, rather than simply jumping to a desired steady state, the controller 120 may chose a more optimal path to arrive there.

The controller 120 may further implement a search process to identify a successive state. During the operate stage as describe above, the current ship-propulsion state, the desired ship-propulsion state, and the acoustic response thresholds are all known. What is to be determined is the optimal steady ship-propulsion state, or what intermediate ship-propulsion states should be used for the transition. This is specific to sub-stages (c) and (d) of the example operate stage presented above. A first task to be performed by the controller in sub-stage (a) is to determine the current ship-propulsion state SPScurrent. Using the same convention per Equation (1), the SPScurrent can be defined a function of engine throttle as percentage of full power P, rudder angle δ, and rudder angle rate as shown in equation (5):

$${SPS}_{Current} = f ( P , δ , \frac{d}{dt} δ ) \qquad ( 5 )$$

To illustrate this process, the example described above regarding a merchant ship may be revisited. In this illustrative scenario, the merchant ship has the autopilot set to travel north at 14 kts. There is a slight set to starboard, and the vessel is maintaining 3 degrees of starboard helm to correct for this and maintain course. A proportional-integral-derivative (PID) controller implemented by the autopilot 110 or controller 120 may provide this 3-degree adjustment, as well as any minor rudder movements required to correct for disturbances such as waves. The operators of the vessel 100 have configured the controller 120 to prevent interfering with marine mammals in the area. The ship operators then decide they want to increase speed to 18 kts. The autopilot 110 knows the relationship between power and speed and that, for instance, 14 kts equates to 40% of max power, and 18 kts equates to 70% of max power. The variable values before the speed change thus are: P=40, δ=3, and d/dt*δ=0. These values can be assigned to SPScurrent per equation (6):

SPS_{Current}=[40][3][0] (6)

The next sub-process stage of this example process is to determine the desired steady ship-propulsion state (SPSDesired). Given that the desired speeds equate to 70% of max power, then P=70. It is also known that the ship was maintaining a steady heading at the current speed with 3 degrees of port helm, and thus δ=3. The value will be later adjusted by the PID as likely a smaller rudder angle will be required at the higher speed, but using δ=3 is sufficient at this time. The vessel is moving to a steady ship-propulsion state, and so d/dt*δ=0. This defines the temporary target state; however, it may be premature to simply assign these values to SPSDesired, as it may exceed the response thresholds. The controller 120 can check the values for the acoustic responses that were mapped to the temporary target state during the calibration stage. In this example, the acoustic response exceeds the acoustic response threshold. The algorithm will then begin searching for the nearest state that will satisfy our response thresholds. The controller 120 may fix the values of δ and d/dt and look for the nearest lower and nearest higher thrust (if it exists) that does satisfy the acoustic response thresholds. In this example, the controller finds that the states corresponding to 68% thrust and 78% thrust have acoustic responses that are less than the response thresholds. The controller 120 in this example is configured to favor whichever state is closest, and therefore chooses P=68. SPSDesired is then gets assigned this value as shown in equation (7):

SPS_{Desired}=[68][3][0] (7)

In this example, the controller 120 is configured such that exceeding acoustic response thresholds during transitions is acceptable, and therefore the controller will pass SPSDesired to the propulsion and maneuvering systems (e.g., the motor controller 152 and steering controller 142. If instead the controller were configured not to exceed thresholds while changing speed, the ship-propulsion state may contain a forth variable: acceleration. In this case, the controller 120 may move along the acceleration dimension of the now four-dimensional data array, keeping the other variables fixed in which to find and select which accelerations should be used as intermediate states. Although the controller 120 may not have direct control over acceleration of the ship, it may effectively control the vessel's acceleration with the use of intermediate states, wherein the controller 120 can order a number of small increases in throttle to be spread out over time.

FIG. 6 is a flow diagram illustrating an example “ad hoc” process 700 that may be implemented by the controller 120 for determining successive states of the motion system. As an alternative to the calibration and operate stages described above, the ad hoc process 700 does not require a calibration stage or a model. The ad hoc process 700, when implemented by the controller 120, may be a separate, stand-alone process that can use the same sensors and information as the combined calibration and operate stages, but bypasses the need for data mapping. Using the ad hoc process 700, the controller 120 may compare a desired state (e.g., speed and heading commands) to the current state of the vessel motion system (e.g., speed, heading, acceleration, rudder angle, throttle) obtained from the navigation sensors 132, motor controller 152 and steering controller 142. If the states are equal, the controller may maintain the current state.

If the states are not equal, then the controller 120 may determine a modified state. To do so, the controller 120 may compare the real-time measurement of the acoustic response, as provided by the acoustic sensors 134, against the acoustic response thresholds. If the response threshold is being exceeded, the controller 120 may modify (e.g., reduce) the command signals of the current ship-propulsion state until the acoustic response is less than the response thresholds. In effect, the controller 120 may operate as a noise limiter by limiting propulsions and maneuvering command signals.

One advantage of the process 700 is that it does not require calibration and, therefore, can be used at any time. Another advantage is that the data used by the controller 120 is more up-to-date, and may be more accurate than the values stored by the controller 120 when the system was last calibrated. Thus, the ad hoc process 700 can be suitable for some uses of a controller in example embodiments.

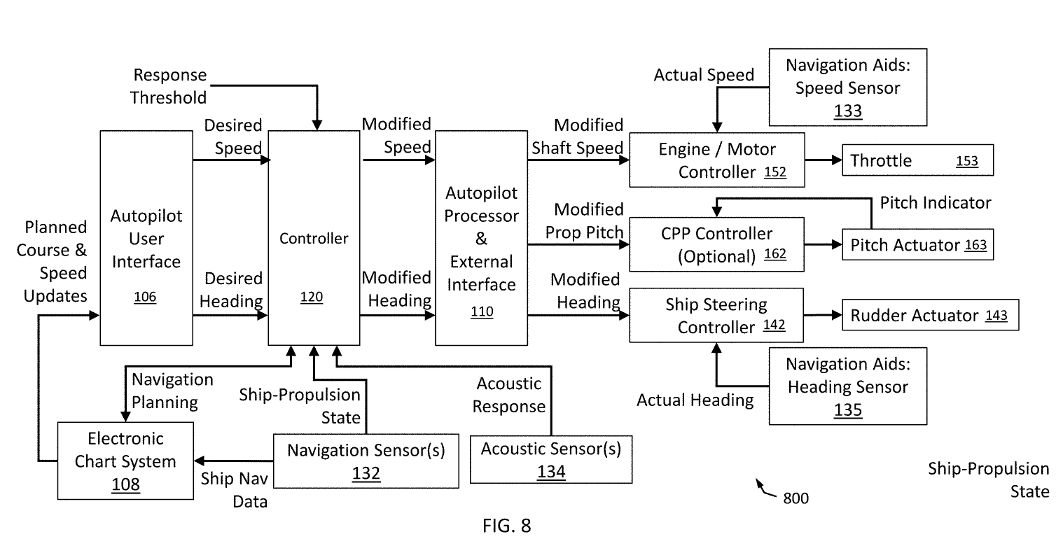

FIG. 8 illustrates a vessel control system 800 in a further embodiment. The system 800 may be one possible version of the control system of the vessel 100 described above, but is shown in further detail to illustrate an example installation of the controller 120 in an existing control system that is absent the controller 120. As shown, the controller 120 is positioned in the control flow between the user interface 106 and the autopilot 110. Such an installation may be feasible if the autopilot 110 can be altered without undue effort, and if there is an ability to intercept signals passed between the user-interface 106 and the autopilot 110. This configuration may be advantageous in that many autopilot controls can remain the same before and after installation of the controller 120, and the user interface 106 may only require a few new features (such as a way to set response thresholds). Another advantage of this arrangement is that the controller 120 may not require a custom output interface that has matching hardware and communications protocols for all the external controllers, as the autopilot's existing hardware can be re-used.

In this configuration once installed, the controller 120, in an operate stage or ad hoc process as described above, may intercept a desired speed and heading from the user interface 106 and output a modified speed and heading to the autopilot 110. The autopilot 110 may then determine a corresponding modified shaft speed and heading, outputting those values to the engine motor controller 152 and steering controller 142, respectively. Optionally, if the system 800 implements a controllable pitch propeller (CPP), the autopilot 110 may also determine a modified propeller pitch to forward to a CPP controller 162. In response, the motor controller 152 may control the motor throttle 153 according to the modified shaft speed and an actual measured speed provided by a speed sensor 133; the ship steering controller 142 may control a rudder actuator 143 based on the modified heading and an actual measured heading provided by a heading sensor 135; and the CPP controller 162 may control a pitch actuator 163 in accordance with the modified propeller pitch and a pitch indicator feedback from the pitch actuator 163.

In an alternative embodiment (not shown), the controller 120 may be positioned entirely before the existing autopilot 110 in the control flow. In this case, the controller 120 passes signals to the autopilot 110 as the user would such that the entire autopilot functions as originally designed. This arrangement may require the controller 120 to have a completely new user interface for both controller-specific functions, such as changing response thresholds, as well as replacing all user-input functionality of the original autopilot. Depending on the circumstances, this configuration may be the preferred option, as it would provide commonality between all ships using the system. As with the implementation shown in FIG. 8, this option keeps the existing autopilot hardware for communicating with the individual system controllers.

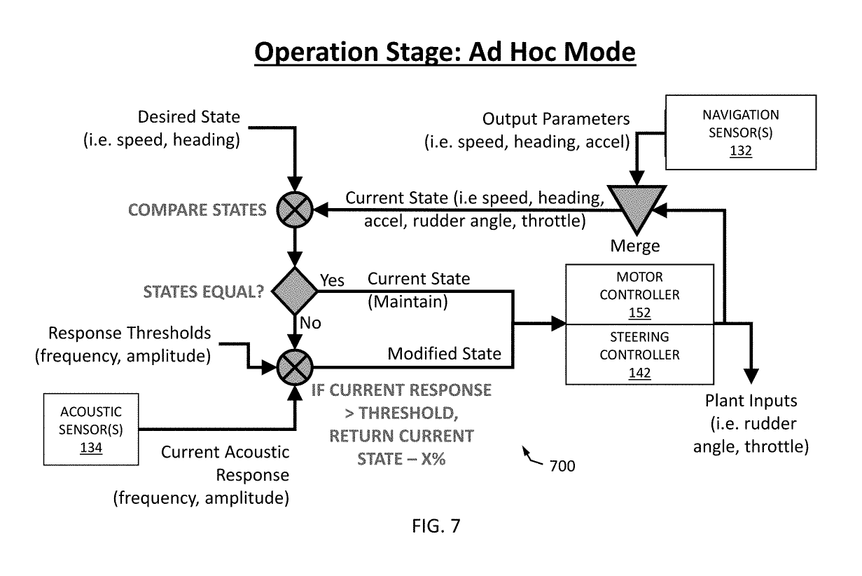

A further possible implementation (not shown) may be to insert the controller 120 entirely after the autopilot 110 in the control flow, as shown in FIG. 1-10. Similar to the configuration of the system 800, this implementation may allow the user to keep much of the existing user interface 106, with only a few additions required. This option may require the controller to have output hardware and protocols for each controller. Even with the use of reconfigurable data ports, this configuration may add to the hardware complexity of the system. However, this configuration can be advantageous in that it allows for the controller to control the CPP controller 162 directly. If the autopilot 110 is configured for fuel efficiency only, and not allow pitch to be changed at higher speeds, then the ability to change pitch directly gives the controller one more degree of freedom in which to change the acoustic responses, providing more options for acoustic-performance optimization.

For some marine vessels, Electronic Charts Systems (ECSs) are used in nautical engineering. An ECS can be used to put down a series of waypoints on an electronic chart (map). Waypoints are connected with straight lines that have a compass direction and a selected speed called a track. A series of connected tracks from the departure location to the destination location form a navigation plan. When creating a navigation plan by laying tracks, waypoints, directions, and speeds are selected such that hazards are avoided, make use of shipping lanes, and comply with location traffic regulation. Further, when making navigation plans, track speeds are often selected to maximize use of fuel-efficient speeds or to drive convenient arrival and departure times.

In further embodiments, with reference to FIG. 1, the controller 120 may exchange data with the ECS 108 to modify the navigation plan to also consider acoustic optimization. Planned ship movements, such as planned speeds, can be sent to the controller 120 from the ECS 108. The controller 120 may then return to the ECS 108, the subset of speeds that are below the selected acoustic thresholds. This process may be iterative, such that a navigation plan becomes a series of tracks that closely meets the original navigation plan, while staying beneath the acoustic thresholds where possible. This modified navigation plan with acoustic optimization may be referred to as a noise management plan. In a further embodiment, ECS 108 that is aware of acoustic threshold limits based on local restrictions, and the controller 120 may pass desired speeds and varying acoustic thresholds to the controller such that a noise management plan can respect conservative localized restrictions, while allowing more noise (e.g., via higher thresholds) in less restricted waterways.

There may be hesitation by marine vessel owners, masters, and crew to allow a new system to alter the way their vessel moves in high-traffic environments and especially in the context of emergency maneuvers to avoid collision or grounding. In anticipation of those concerns, a bypass switch may be installed to optionally disengage the controller 120, enabling the user to take direct control of the vessel motion system.

While example embodiments have been particularly shown and described, it will be understood by those skilled in the art that various changes in form and details may be made therein without departing from the scope of the embodiments encompassed by the appended claims.

What is claimed is:

1. A method of operating a motion system of a vessel, comprising:
during a training phase:
for each of a plurality of states of the motion system, 1) measuring motion of the vessel concurrent with parameters of the motion system, and 2) measuring acoustic response associated with the motion; and
defining a model representing the plurality of states, the model relating the parameters signals, vessel motion, and acoustic response associated with each of the plurality of states; and
during an operating phase:
determining, based on the model, a subset of the plurality of states to satisfy a motion goal and an acoustic threshold; and
operating the motion system to maneuver the vessel according to the subset of the plurality of states.

2. The method of claim 1, wherein determining the subset of the plurality of states includes:
identifying a set of eligible states, the eligible states having an associated acoustic response below the acoustic threshold; and
determining a sequence of states selected from the eligible states, the sequence of states satisfying the motion goal when performed by the motion system, the subset including the sequence of states.

3. The method of claim 2, wherein operating the motion system includes controlling the motion system to perform the sequence of states to maneuver the vessel in accordance with the acoustic threshold.

4. The method of claim 2, wherein the sequence of states enables the motion system to satisfy the motion goal in a minimal time period relative to alternative states.

5. The method of claim 1, wherein the parameters include at least one of a propeller shaft speed, a propeller pitch, a rudder angle, actuation of a control surfaces, a thruster direction, a thruster speed, a waterjet direction, a waterjet speed, and a dynamic ballast control value.

6. The method of claim 1, wherein the motion includes at least one of speed, turn rate, and acceleration of the vessel.

7. The method of claim 1, wherein the acoustic response includes at least one of frequency, amplitude, duration, and direction.

8. The method of claim 1, wherein the motion goal indicates a required speed and direction of the vessel.

9. The method of claim 1, further comprising determining the motion goal based on a user-entered destination and time of arrival.

10. The method of claim 1, further comprising determining the acoustic threshold based on at least one user-entered value corresponding to at least one maximum amplitude and at least one frequency range.

11. The method of claim 1, wherein the acoustic threshold indicates a frequency range and a respective amplitude.

12. The method of claim 1, wherein the plurality of states are distinct from one another via at least one of the respective parameters and the motion.

13. The method of claim 1, wherein the acoustic threshold is one of 1) a persistent value that remains static until changed by the user, and 2) a value that dynamically adjusts relative to a variable reference input.

14. The method of claim 1, wherein the acoustic response is based on output of at least one acoustic sensor or accelerometer at the vessel.

15. The method of claim 1, wherein the motion goal indicates a user-entered speed and a user-entered direction, and wherein the subset of the plurality of states indicate a speed and a direction that is distinct from the user-entered speed and the user-entered direction.

16. The method of claim 1, further comprising modifying a motion command to correspond to the parameters of at least one of the subset of states.

17. The method of claim 1, further comprising, during the operating phase, updating the model based on a measured acoustic response.

18. The method of claim 1, wherein the model includes a map of the parameters, motion, and acoustic response associated with each of the plurality of states.

19. The method of claim 1, wherein the parameters of the motion system include at least one of commands directed to the motion system and a feedback signal output by the motion system.

20. The method of claim 1, further comprising:
receiving a navigation plan from an electronic charts system (ECS), the navigation plan defining a plurality of movements to be executed by the vessel; and
modifying the navigation plan, based on the model, to determine a modified plurality of movements that, when executed by the vessel, satisfy the acoustic threshold.

21. A method of training a vessel maneuvering and propulsion system, the method comprising:
observing acoustic energy output to water at a vessel as a function of operating states and motion of the vessel to produce a cause-effect acoustic model; and
training the vessel maneuvering and propulsion system for at least a subset of maneuvering and propulsion states based on the cause-effect acoustic model.

22. A method of operating a motion system of a vessel, comprising:
applying a motion goal and an acoustic threshold to a model representing a plurality of states of the motion system, the model relating parameters directed to the motion system, motion of the vessel, and acoustic response associated with each of the plurality of states;
determining, based on the model, a subset of the plurality of states to satisfy the motion goal and acoustic threshold; and
operating the motion system to maneuver the vessel according to the subset of the plurality of states.

23. A system for operating a vessel, comprising:
at least one acoustic sensor configured to measure an acoustic response of the vessel; and
a controller configured to interface with a motion system of the vessel, the controller further configured to:
during a training phase:
for each of a plurality of states of the motion system, 1) measure motion of the vessel concurrent with parameters of the motion system, and 2) measure acoustic response associated with the motion; and
define a model representing the plurality of states, the model relating the parameters, motion, and acoustic response associated with each of the plurality of states; and
during an operating phase:
determine, based on the model, a subset of the plurality of states to satisfy a motion goal and an acoustic threshold; and
operate the motion system to maneuver the vessel according to the subset of the plurality of states.

24. The system of claim 23, wherein the controller is further configured to:
identify a set of eligible states, the eligible states having an associated acoustic response below the acoustic threshold; and
determine a sequence of states selected from the eligible states, the sequence of states satisfying the motion goal when performed by the motion system, the subset including the sequence of states.

25. The system of claim 24, wherein the controller is further configured to control the motion system to perform the sequence of states to maneuver the vessel in accordance with the acoustic threshold.

26. The system of claim 24, wherein the sequence of states enables the motion system to satisfy the motion goal in a minimal time period relative to alternative states.

27. The system of claim 23, wherein the parameters include at least one of a propeller shaft speed, a propeller pitch, a rudder angle, actuation of a control surfaces, a thruster direction, a thruster speed, a waterjet direction, a waterjet speed, and a dynamic ballast control value.
